(19) United States
(12) Patent Application Publication
(10) Pub. No.: US 2019/0107815 A1
(43) Pub. Date: Apr. 11, 2019

(54) DATA ARCHITECTURE AND IMPROVED MODEL OBJECT INTERFACES FOR SUPPORTING INTEGRATION OF MULTIPLE DISPARATE DATABASES USEABLE TO MODEL AVAILABILITY OF A FLEET OF VEHICLES

(71) Applicant: THE BOEING COMPANY, Chicago, IL (US)

(72) Inventors: Adrienne P. Miller, Kent, WA (US); Steven E. Saylor, Auburn, WA (US); Henry L. Scheurman, Bellevue, WA (US)

(21) Appl. No.: 15/725,559

(22) Filed: Oct. 5, 2017

(51) Int. Cl. G05B 17/02; G06Q 10/06; G06F 17/30; G06Q 10/08

(52) U.S. Cl. CPC G05B 17/02; G06Q 10/08; G06F 17/30557; G06Q 10/06315

(57) ABSTRACT

A data architecture and model object interfaces for supporting integration of multiple disparate databases useable to model availability of a fleet of vehicles. An operations database contains first data specifying a first operational scenario. A first operating base database contains second data specifying first supply chain related data that relates to a first operating base. A results database receives post-simulation results of a simulation of operation and maintenance of the fleet. A core database contains third data and the model object interfaces. The third data and the model object interfaces are configured to allow integration of the operations database, the first operating base database, the results database, and simulation software configured to simulate the operation and maintenance of the fleet.

### BACKGROUND INFORMATION

### 1. Field

The present disclosure relates to an improved data architecture and improved model object interfaces for supporting integration of multiple disparate databases useable to model availability of a fleet of vehicles.

### 2. Background

An aerospace company is sometimes interested in simulating operation of a fleet of aircraft to support an ongoing operational concern. In particular, an aerospace company may be interested in planning for actually providing such support to a customer. For example, an aerospace company may be interested in providing a customer with immediate air tanker refueling support eighty percent of the time anywhere in the world. To provide such a service, the aerospace company may need to model reliability and sustainability of a fleet of aircraft, along with spares & maintenance requirements.

However, technical challenges exist for actually implementing such a model in a computer. In particular, current data architectures and object interfaces do not allow for an adequate model of the operation of a fleet of aircraft.

### SUMMARY

The illustrative embodiments provide for a data structure comprising a data architecture and model object interfaces for supporting integration of multiple disparate databases useable to model availability of a fleet of vehicles comprising a plurality of vehicles. The data structure further includes an operations database containing first data specifying a first operational scenario for operating the fleet of vehicles. The data structure further includes a first operating base database containing second data specifying first supply chain related data that relates to a first operating base at which the fleet of vehicles may operate. The data structure further includes a results database containing a particular data structure configured to receive post-simulation results of a simulation of operation and maintenance of the fleet of vehicles. The data structure further includes a core database containing third data and the model object interfaces. The third data and the model object interfaces are configured to allow integration of the operations database, the first operating base database, the results database, and simulation software configured to simulate the operation and maintenance of the fleet of vehicles.

The illustrative embodiments also provide for a method for modeling availability of a fleet of vehicles using a data structure comprising a data architecture and model object interfaces for supporting integration of multiple disparate databases, the method executed solely in a computer. The method includes receiving a demand model in an operations database containing first data specifying a first operational scenario for operating the fleet of vehicles. The method also includes receiving a command to simulate at simulation software configured to simulate the operation and maintenance of the fleet of vehicles. The method also includes receiving, based on the demand model, input from a first operating base database containing second data specifying first supply chain related data that relates to a first operating base at which the fleet of vehicles may operate. The method also includes integrating the demand model and the first operating base database using a core database containing third data and the model object interfaces. The third data and the model object interfaces are configured to allow integration of the operations database, and the first operating base database. The method also includes exporting results of the simulation to a results database containing a particular data structure configured to receive post-simulation results of the simulation of operation and maintenance of the fleet of vehicles.

The illustrative embodiments also provide for a computer comprising a processor and a non-transitory computer recordable storage medium storing program code, which when executed by a computer, performs the above-described method. The illustrative embodiments also provide for a non-transitory computer-recordable storage medium storing program code, which when executed by a computer, performs the above-described method.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1A is an illustration of a flight operations process flow, in accordance with an illustrative embodiment;

FIG. 1B is an illustration of a flight operations process flow, in accordance with an illustrative embodiment;

FIG. 2 is an illustration of an overall data architecture including model databases, in accordance with an illustrative embodiment;

FIG. 3 is an illustration of a block diagram of an analysis process for evaluating sustainment system impact on fleet readiness, in accordance with an illustrative embodiment;

FIG. 4 is an illustration of a block diagram of a high-level simulation configuration process, in accordance with an illustrative embodiment;

FIG. 5 is an illustration of a block diagram of a data object architecture, in accordance with an illustrative embodiment;

FIG. 6 is an illustration of a block diagram of a demand model architecture, in accordance with an illustrative embodiment;

FIG. 7 is an illustration of a block diagram of a supply chain model architecture, in accordance with an illustrative embodiment;

FIG. 8 is an illustration of a block diagram of two different supply chain model architectures, in accordance with an illustrative embodiment;

FIG. 9 is an illustration of a block diagram of an improved data architecture, in accordance with an illustrative embodiment;

FIG. 10 is an illustration of a flow chart of a process for modeling servicing of a fleet of aircraft using an improved data architecture, in accordance with an illustrative embodiment; and

FIG. 11 is an illustration of a data processing system, in accordance with an illustrative embodiment.

### DETAILED DESCRIPTION

The illustrative embodiments recognize and take into account that an issue that arises in formulating an accurate model of a performance based contract for a fleet of vehicles and attendant costs is already mentioned above: integrating disparate databases. As used herein, the term “disparate” means databases that differ in content with respect to each other so that one database cannot, without the illustrative embodiments, be used in place of another or cannot be read in the same way. Another issue that arises in formulating an accurate model of a performance based contract for a fleet of vehicles and attendant costs is that the dynamic nature of the underlying resources required to be used in the model makes it challenging for any single system to accurately model the demands for the resources.

Therefore, the illustrative embodiments provide for an improved data architecture and improved model object interfaces for supporting integration of multiple disparate databases useable to model availability of a fleet of vehicles. Together, the data architecture and the improved model object interfaces overcome the issues described above.

The illustrative embodiments also recognize and take into account that the improved data architecture and improved model object interfaces enable software for simulating or modeling maintenance of a fleet of aircraft over a period of time. Without such technical improvements rooted in computer technology, it would not be possible to produce a sufficiently accurate model of the requirements and costs of performing a performance based service contract.

Without a sufficiently accurate model, any performance contract bid submitted is likely to be either an overestimate or underestimate of true costs, which is unacceptable for the reasons described above in the Background of this document. However, with an accurate model, an aerospace company is able to submit a bid which more accurately reflects what would be the true costs of performing the contract over a period of time, typically years.

The illustrative embodiments also recognize and take into account that some customers are increasingly requesting performance based service contracts. As described above, these contracts require bidding on a particular performance or demand level. As a specific example, a request for bid may call for a contract that supports maintenance of a fleet of refueling tanker aircraft such that at least one refueling tanker is available anywhere in the world eighty percent of the time. In order to accurately bid on such a contract, the demands for resources, including but not limited to parts, aircraft, mechanics, facilities, money, time, and many other factors, must be considered. However, again, the dynamic nature of these resources makes it challenging for any single system to accurately model the demands for these resources.

Thus, the technical effect of the illustrative embodiments is to create an improved data architecture and improved model object interfaces to enable software for simulating or modeling maintenance of a fleet of aircraft over a period of time. The goal of the illustrative embodiments is to provide this technical solution rooted in computer technology. The technical solution enables simulations of demand models on a simulated fleet of aircraft or other vehicles so that a company can submit an accurate bid on a service based contract for the aircraft or vehicles. Demand models are defined below.

The illustrative embodiments may function through a combination of dynamic relational databases, user inputs, mission profiles, and resource data. Various resource types have varying resource attributes. For example, “parts” may include attributes related to aircraft applicability, while maintenance technicians may have attributes related to scheduled work hours and locations. A particular mission objective may be added by the user, or automatically. For example, a mission objective could be providing a refueling tanker anywhere in the world eighty percent of the time. With the given mission parameters, the illustrative embodiments enable a query on several relational databases to determine whether there are sufficient resources to meet the mission parameters.

In one illustrative embodiment, the illustrative embodiments may be described as a system for demand model simulation. The system includes a dynamic relational database with data representing available resources. The data represents available resources including a plurality of attributes associated with each of a plurality of resources. The system also includes a communications module in constant communication with the database and a processor. The processor may be configured to receive a demand model request from a user and, via the communications module, query the database for available resources to meet the demand model. The demand model may operate in accordance with a desired mission profile to produce a resulting level of availability as a function of available resources, inventory, and other elements necessary to support operation of the fleet.

The illustrative embodiments also provide for the mission profile being a description of the desired use of the fleet at any location over time. The illustrative embodiments also provide for the resources being stored in the database along with attributes associated with each resource type. The illustrative embodiments also provide for the resources being comprised of parts, aircrafts, maintenance personnel, maintenance equipment, and storage facilities. Further variations are also possible.

Attention is now turned to additional detail regarding issues addressed by the illustrative embodiments. The system operations simulation framework of the illustrative embodiments supports both early design trade studies for reliability and sustainability assessment and post-production system sustainment business development activities. In both areas, there is a need for strategic trade studies to assess the likelihood that the system can be sustained to expected levels as a function of alternatives under consideration. The illustrative embodiments support the development and re-use of system simulations that generate demand on a supply chain. Such system simulations may be referred to as “demand models”.

System demand models are not limited to a single domain and may span the full spectrum of aircraft, ground vehicle, ground station, and undersea vehicle system types. These models have been designed within a common framework to interface with our supply chain model environment described in U.S. Pat. No. 9,372,917, or to operate separately with a simplified supply chain representation, depending on analysis needs. The tools and approach described herein specifically address the need to quantify system performance and performance variation due to scenario and system attributes that change over time. These attributes allow a forecast of future system behavior, which may be transient in nature, to support business decisions and program risk reduction.

The illustrative embodiments support several analysis metrics. These metrics include system availability over time, part demands over time, non-mission capable due to supply (NMCS) rates over time, non-mission capable due to maintenance (NMCM) rates, maintenance man-hours per operating or flight hour, and others. Typical analysis questions include the following: What is the likelihood that a given planned support concept will achieve contracted fleet availability thresholds over the next 10 years? Another typical analysis question may be: What is the benefit to the customer for a company's proposed common parts pool solution? Another typical analysis question may be: What is the expected demand of spares over time as the operational tempo changes, and can the supply chain keep up? Another typical analysis question may be: How long does it take to recover inventory to target levels? Another typical analysis question may be: What happens to the fleet if the part repair budget is reduced by 10%? Another typical analysis question may be: What inventory investment and resource levels are required to assure contractual metrics will be met under a performance-based logistics contract? Many other questions may be desirably addressed.

However, computer-centric technical challenges remain for actually answering these questions in a meaningful way. These challenges are described above. The illustrative embodiments enable a computer to address these challenges.

Thus, the simulation tools described herein have been designed for use on multiple programs. However, each program may have some unique characteristics. It is an attribute of the approach described herein that the model can be easily scaled for different scenarios, such as the number of bases, numbers of aircraft, and numbers of parts, and that the model capabilities can be tailored for unique logic or metrics.

There are at least three variations of system operations models that illustrate the approach described herein. These include the logistics fleet availability model, the component demand models, and the ground system availability model.

The Logistics Fleet Availability Model (LFAM) is used to model aircraft fleet operations as impacted by supply chain performance, sparing plans, part criticality for missions, scheduled and unscheduled part removals, mission schedules, and maintenance resource requirements. Aircraft change state over time during simulated operations.

The Component Demand Models (CDM) provide insight into the future spares demand profiles, such as magnitude, timing, and variation, for flight control surfaces and landing gear components. These models are designed with custom data object relationships to associate each aircraft with unique initial part fight hours and landing data derived from Navy data sources. There is also custom logic. The models re-use the same overall simulation framework as LFAM, including interfaces to other databases.

The Ground System Availability Model (GSAM) supports capture for a large proprietary service contract of a fleet of vehicles. GSAM can be used to verify and validate that all required system availability metrics will be met. As with LFAM, GSAM is designed to operate as a stand-alone simulation model and also integrate with the supply chain simulation architecture described herein.

Attention is now turned to existing simulation models. There are a handful of existing tools that aim to model fleet operations for sustainment performance prediction. There is a United States Air Force standard tool called Logistics Composite Model (LCOM). LCOM is difficult to use and is designed for maintenance task planning; it does not address the impact of supply chain performance. LCOM is also significantly limited in the scale of scenario size: the number of bases and the number of aircraft that it can handle. Thus, LCOM does not experience the computer-centric technical challenges underlying the goals of the illustrative embodiments.

There is also a reliability and maintainability engineering design tool called Windchill Reliability Block Diagram (RBD) that has a system availability metric, but also does not scale well to fleets of aircraft. Other commercial tools include SIMLOX and Aerogility. A major drawback of these existing tools is that they are not customizable. The lack of ability to adapt system logic to specific program needs, unique metrics, or business rules means that instead of modeling the system attributes required to directly examine the issues of interest, a user would be forced to approximate the system behavior in more generic ways that may not answer required questions. Because of the lack of adaptability, these tools also do not face the same computer-centric challenges which are faced by the illustrative embodiments.

There are existing inventory demand forecasting tools as well. Service Planning & Optimization (SPO) is an inventory optimization tool which makes recommendations for target stocking levels as a function of expected demand. Inventory optimization tools like SPO create analytic solutions based on expected statistical values, and are not able to study the support system transients and variation that are required to fully understand performance risk. A benefit of our tool suite is the ability to test and validate the solutions proposed by the optimizers. However, this benefit requires a technical, computer-centric solution to the issues described above.

Attention is now turned to a more detailed overview of the illustrative embodiments. The illustrative embodiments include a system operations simulation framework having multiple demand models, which have both common and unique characteristics. Common to all demand models is a data architecture which has five characteristics. These characteristics include database-driven architectures, scalability, extensibility, interface to supply chain simulations, and modular metrics. Each of these characteristics is described in more detail below.

The data architecture of demand models is database driven. All scenario data and system attributes are contained in an underlying data architecture that can be managed and maintained outside the simulation environment. When the data is imported into the simulation environment, model objects are instantiated as required and do not require further user configuration. The model data architectures and model object interfaces are novel.

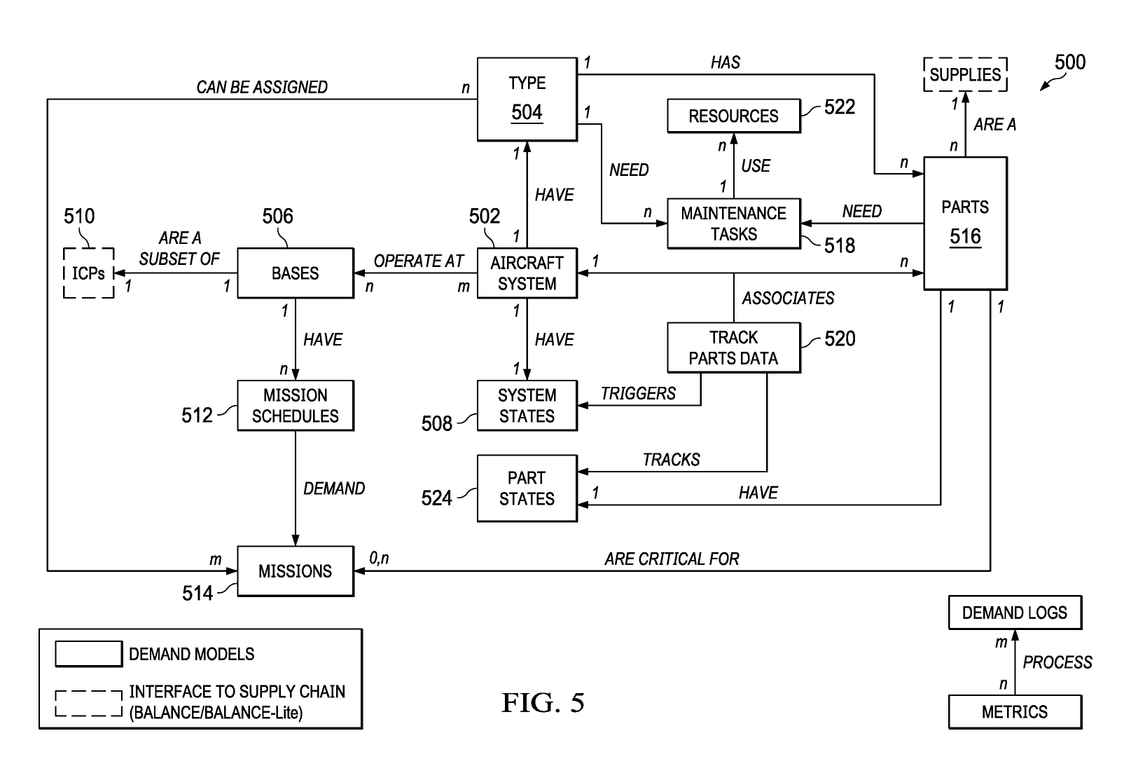

The data architecture of demand models is scalable. The model data architecture is designed to allow a variable number of bases, aircraft, and parts which can be defined in multiple combinations. See also FIG. 6.

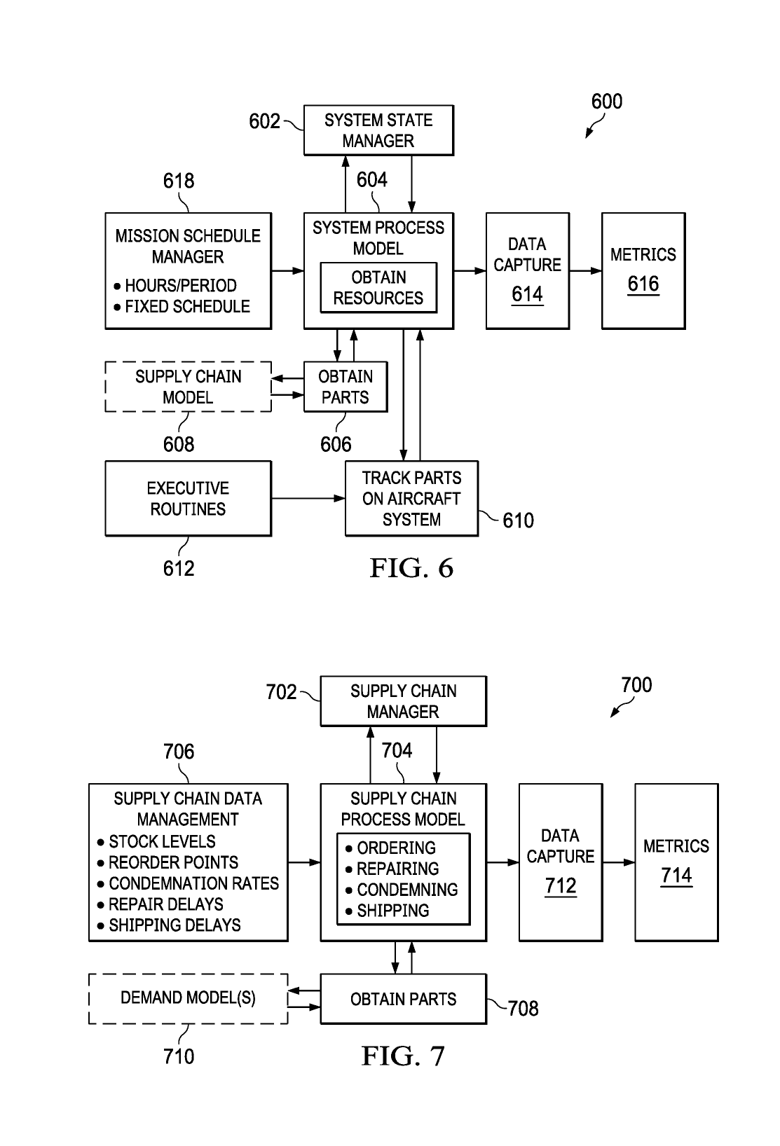

The data architecture of demand models is extensible. The model architectures are designed to be extensible to accommodate customized processes and business rules. The component demand model and ground system availability models, described further below, are examples of the ability to re-use the architecture and design approach to support unique program requirements. See also FIG. 7.

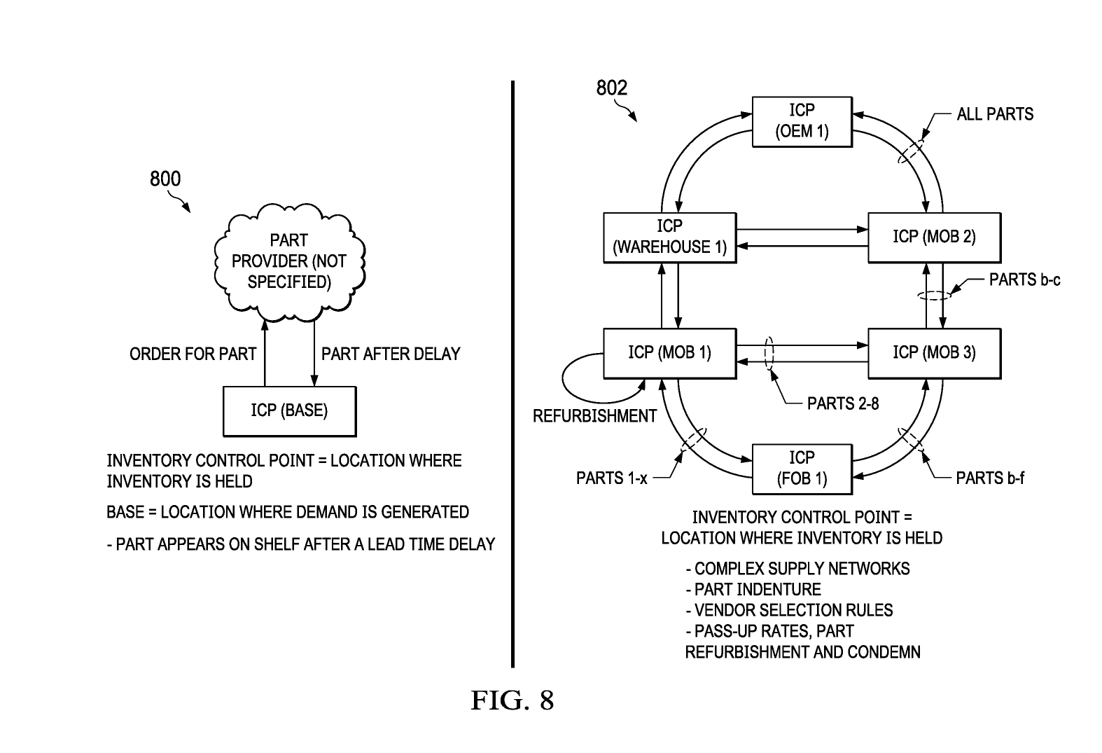

The data architecture of demand models provides an interface to supply chain simulations. An example of a supply chain simulation is shown in our U.S. Pat. No. 9,372,917. The interface design minimizes interfaces to code objects and segregates supply chain simulation operations from the system operations models. This approach allows for a high degree of code re-usability, a high degree of flexibility in creating demand models with unique business rules, and an ability to upgrade to new versions of supply chain models without changing anything in the demand models. See also FIG. 8 for a high-level depiction of the supply chain model architecture and interface.

The data architecture of demand models provides for modular metrics. The demand models are designed with an extensible set of metrics that can be added or removed from the models depending on analysis needs by simply dropping them into the model or deleting them. The metrics modules create their own database structures and register themselves for access to relevant model data and history tables. As the model runs, or at the end of a run, the metrics modules execute the required algorithms to derive the metric of interest and record the data to a results database, or a plotter, or both. If removed from the model, the metrics modules automatically clean up after themselves and remove their associated data structures from the model. This approach allows for easy modification of models for unique metrics if desired.

The illustrative embodiments also provide for a component model for specific aircraft. The component model of the illustrative embodiments has several unique features.

The data architecture of the component model includes initial flight hours (FH) specified for each part on each aircraft. The data architecture of the illustrative embodiments provides for initial flight hours by part for each aircraft.

The data architecture of the component model includes custom part removal logic (e.g., parts needing scheduled inspections before life limits are reached). The model has the capability to specify that there are interim scheduled part removals and repairs before life out.

The data architecture of the component model includes part life limits. Life limits for each part can be specified either at the part level or at the part/aircraft instance level. For landing gear parts, each part/aircraft instance has specified data for various types of landings and specific landing equations or sets of landing equations that must be evaluated for that part to determine life out criteria.

The data architecture of the component model includes landing gear life-out equations. The landing gear life-out equations have been designed into their own model object that responds to system simulation inquiries about the current state of a specific aircraft-part combination.

The data architecture of the component model accounts for alternate supply. The model data architecture and logic has been tailored to include the concept of an alternate supply that can be substituted if the original supply is not available. This feature is made possible by the design decision (common to all demand models) that abstracts parts from supplies.

The data architecture of the component model includes custom decision logic regarding which part variant to request (original or alternate). Without making any changes to the supply chain model simulation logic, the illustrative embodiments provide custom rules to determine which part to request from up-echelon supply chain nodes based on the state of the inventory at those locations.

The data architecture of the component model includes alternative part attributes by aircraft type. Data structures and model logic of the illustrative embodiments to allow a part on some aircraft to have different characteristics is typical. For example, we can model a subset of aircraft that have a version of the part that is known to fail at a different rate, or needs to be replaced due to life limits at a different time.

The data architecture of the component model includes repair and replace decision logic. Custom logic is provided to allow for a decision to repair or life-out a failed part based on how much life is remaining or other part attributes (repair cost, procurement cost, inventory levels, etc.).

The data architecture of the component model includes recycling of parts off of retired aircraft. When aircraft reach retirement dates or other retirement criteria (e.g., platform flight hours) the model logic allows for parts on that aircraft that have remaining life to be salvaged and placed back into inventory based on user defined thresholds and schedules.

The data architecture of the component model includes part backorders. To replicate real world initial conditions, the model uses the concept of outstanding back-orders to consume parts that arrive into inventory. These parts are then not available to support the simulated flight operations.

The data architecture of the component model includes manufacturing and repair capacity for parts. The component demand models of the illustrative embodiments can add a repair and manufacturing constraint model, as required, to limit the throughput of spares and repairs. This capability is used to reflect the real world limitations on capacity so that we can perform trade studies to examine when orders would have to be made to meet a future demand.

The data architecture of the component model includes induction of parts that require maintenance into repair at simulation start or over time. The component demand models have functionality to start with a quantity of simulated parts to be in maintenance that can be injected into the simulated repair processes over time, in order to reflect initial conditions.

The data architecture of the component model includes inspection thresholds. The component demand models of the illustrative embodiments include the capability to pull aircraft into Depot level inspections based on flight hour thresholds. While aircraft are doing these inspections they do not generate component demand, but they are also not available. This capability is used to examine the impact of aircraft downtime on demand forecasts, as well as estimating the fraction of the fleet that might be available in the future.

The data architecture of the illustrative embodiments also provides for a unique ground system availability model (GSAM). The GSAM provides for multiple simultaneous ground station configurations. This feature allows upwards scalability of simulation scenarios to include multiple-bases, and multiple and mixed ground station configurations featuring different allocations of parts across different configuration types.

The GSAM provides for multiple part removal modes. This capability allows both unscheduled random events which indicate when parts need to be removed based on operating hours to be modeled in conjunction with scheduled part removal and part operating life limits.

The GSAM provides for multiple scheduled system maintenance levels and locations (base-level and depot-level). This capability allows multiple system maintenance modes and locations for direct accounting of system downtime due to planned system-level maintenance, and to account for specific, metrics distinction based on location where maintenance is performed.

The GSAM provides for part criticality. This capability allows a distinction between critical part non-availability or removal that requires the system be brought down to conduct maintenance, and non-critical part related maintenance wherein the system can continue to operate during maintenance.

The GSAM provides for labor constraints on part-level and system-level maintenance. This capability includes a design for a resource constraint and management scheme so that all activities at a base or depot may compete for resources (labor, equipment, etc.). Resources may be specified in fractional amounts to account for level of effort over the duration of a task.

The GSAM provides for quantity per part sets/part redundancy. If more than one instance of a part (quantity per assembly greater than 1) is present on a system and part redundancy information is specified, GSAM will generate a “QPA Sets” (quantity per assembly sets) data structure entry and manage the status of the system to reflect correct maintenance criticality for the set of operational parts.

The GSAM provides for an interface to supply chain simulations. This capability allows direct interface of the GSAM demand model to supply chain modeling architectures.

The illustrative embodiments also recognize and take into account that, from time to time, an aerospace company may be interested in submitting a bid on a contract for performance based services servicing a fleet of aircraft. However, determining a bid which accurately predicts the true cost of maintaining a fleet of aircraft is very difficult, depending on a great many variables and requiring integration of information from many disparate and possibly incompatible databases; that is, databases that vary in content and structure. The aerospace company does not want to underbid, as then the company may lose money in the performance of the contract. The aerospace company does not want to overbid, as then the company may lose the contract to a competitor.

Therefore, there is also a need to submit a bid for a performance based service contract that is both accurate and specifically tailored to a customer's specified needs. However, technical challenges rooted in computer technology have prevented implementation of a modeling system which satisfies these needs.

Attention is now turned to technical differences between the illustrative embodiments and any prior tools currently available. The illustrative embodiments use a discrete event simulation, which allows the capability to explicitly examine both randomness and system state changes that are the result of process outcomes or decision logic in the models. Other tools are not simulations, or don't have the framework and data architecture presented herein that allows a user to work with multiple programs and customize the logic as required.

An important technical feature of the illustrative embodiments is the interface between the simulation model and the supply chain model. This interface supports scalability, functional design to support re-use and extensibility, comprehensive log history files, and modular metrics. This feature allows for flexibility and the ability to integrate many different programs, databases, and modeling programs into an integrated whole.

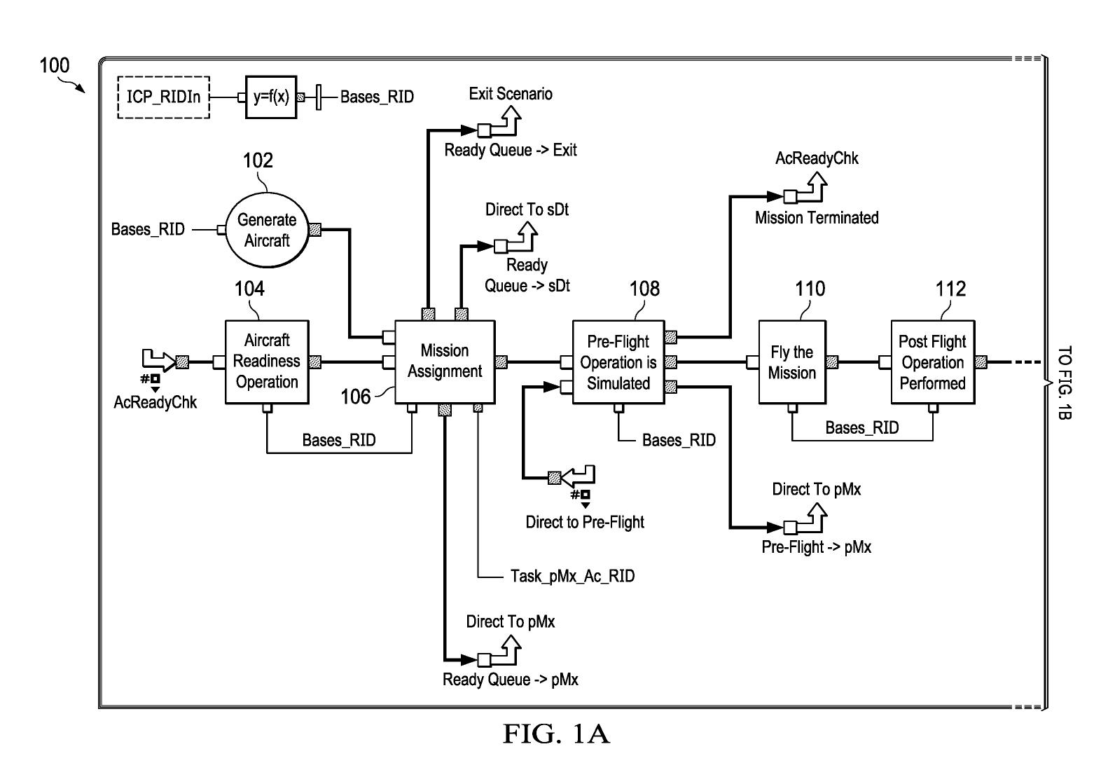

FIG. 1A is an illustration of a flight operations process flow, in accordance with an illustrative embodiment. FIG. 1B is an illustration of a flight operations process flow, in accordance with an illustrative embodiment. Together, FIG. 1A and FIG. 1B may be referred to as “FIG. 1”.

FIG. 1 is an illustration of a flight operations process flow, in accordance with an illustrative embodiment. FIG. 1 shows a process for modeling operation of a fleet of aircraft and determining what parts and labor and other factors are necessary to support a particular availability for a fleet of vehicles. The fleet of vehicles may be aircraft, though may also be automobiles, watercraft, submarines, or other types of vehicles. FIG. 1 is a representation of what simulation software of the illustrative embodiments accomplishes and provides an overview and context for the use of the data architecture and model interfaces described elsewhere herein. FIG. 1 is implemented using a computer.

The Logistics Fleet Availability Model (LFAM) of the illustrative embodiments is a discrete-event simulation. As such, simulated vehicles (aircraft, in this case) flow through a sequence of activities which may be triggered by random events. Random events may include simulated part failures, labor shortages, and other possible issues.

The functional flow of FIG. 1 may be read generally from left to right. Aircraft enter the model and flow through the flight operations process, taking appropriate branches in the flow when events occur as the simulation runs. Aircraft are assigned to missions based on their configuration and current status. As aircraft conduct missions they accrue flight hours and landing cycles. Modeled parts or systems on the aircraft may be subject to planned or unplanned removal and replacement as a function of flight hours, cycles, or calendar time. The aircraft may be subject to scheduled inspections or maintenance activities that cause downtime at regular intervals. The aircraft may also experience delays due to various flight operations (pre-flight, post-flight, etc.), which may be constrained by available resources. The user may specify what activities, if any, comprise “Aircraft Readiness Operation”, “Pre-Flight Operation”, “Post-Flight Operation”, and “Fault Isolation”. Each of the blocks in the flow diagram of FIG. 1 are also hierarchical blocks and contain lower level process models and code. A hierarchical block can be decomposed into higher fidelity logic.

Several abbreviations are shown in FIG. 1. The abbreviations are defined as follows. The term “RID” means “record index.” The term “Chk” means “check.” The term “sDt” means “scheduled down time”. The term “pMx” means “part maintenance”. The term “Ac” means “aircraft.”

The larger arrows refer to shortcuts that are associated with routes that an aircraft might take through the process flow of FIG. 1. For example, an output of a “pre-flight operation” might be that the mission was terminated, such that the aircraft returns via “AcReadyChk” to the aircraft readiness operation.

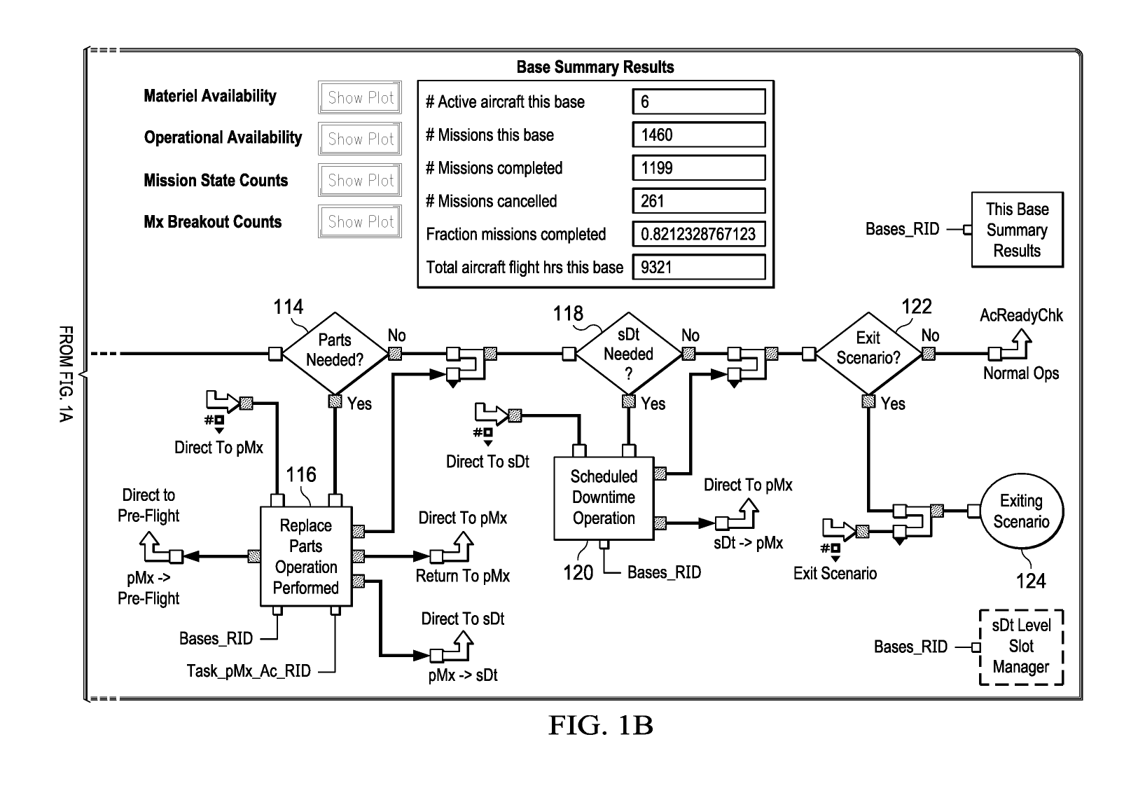

Input and output is to the data architecture described above and also described with respect to FIG. 2 through FIG. 11. The smaller arrows refer to process flow among the blocks and operations shown in FIG. 1.

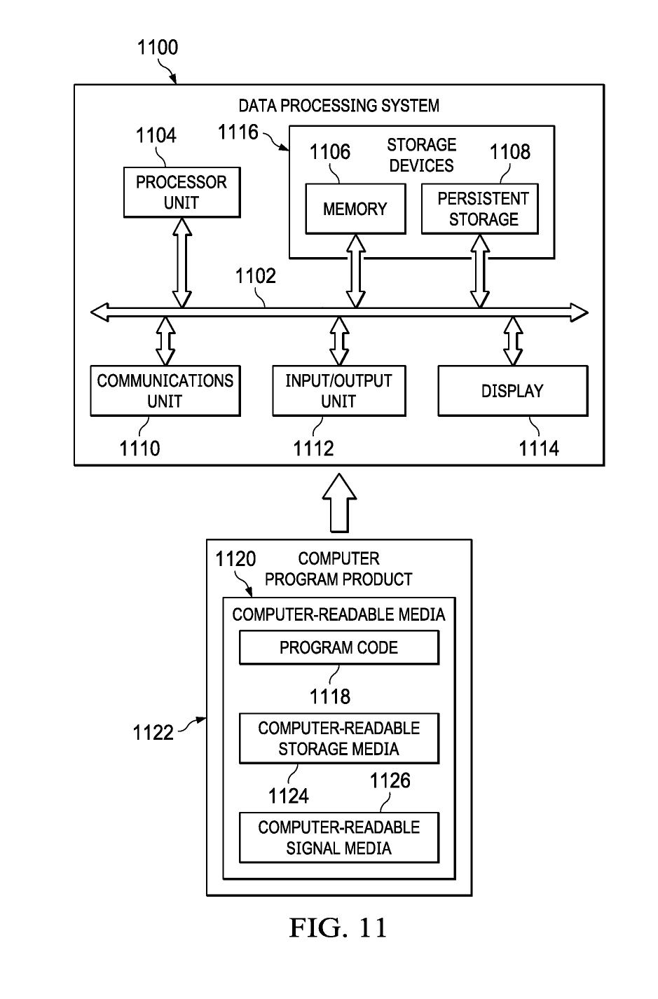

Process 100 may be implemented using one or more data processing systems, such as data processing system 1100 of FIG. 11. Process 100 is only implemented in a data processing system, and is not suitable for human processing or pen and paper processing due to the need to accommodate different data types present in the underlying data structure and the need to account for changes in data over time as a result of interacting events.

Process 100 is described with respect to a fleet of aircraft. However, process 100 may also be modified to be used with respect to other vehicles, or other devices that are operated and sustained over time. Thus, the illustrative embodiments are not necessarily limited to aircraft, even if FIG. 1 only refers to aircraft.

Process 100 may begin by generating aircraft into the fleet of aircraft (operation 102). Generation of aircraft into the fleet may be in accordance with a time-phased delivery schedule by base. This operation may also include receiving record indexes of bases in the simulation. The significance of the record indices noted here is that they are used as part of a data structure for implementing the operation (in this case, generating aircraft that belong at this base). A base is a ground location where aircraft are maintained and operated. Alternatively, aircraft may return from downstream processes and be routed to a readiness operation (operation 104). The Aircraft Readiness Operation (104) enables inclusion of any processes and actions executed following completion of a maintenance activity and prior to mission assignment operations.

Information generated in operation 102 and operation 104 is then passed to the computer to perform mission assignment (operation 106). “Mission assignment” refers to the task or tasks the aircraft will perform. Depending on the state of individual aircraft data objects they may exit the scenario, be sent directly to a scheduled downtime operation, or a part maintenance operation. The Mission Assignment Operation (operation 106) may also generate a task part maintenance aircraft record index trigger to cause an aircraft currently undergoing a Replace Parts Operation (operation 116) to be assigned the mission.

Next, pre-flight operation is simulated (operation 108). This operation may take into account the bases record index in order to invoke pre-flight processes associated with a specific base. The pre-flight operation (operation 108) executes data structures and computer logic for accomplishing resource allocations and task execution for a set of activities that must be executed prior to flying an assigned mission. The results may be stored in an operations database (see operations database 202 of FIG. 2). If not ready for flight, due to independent event timing associated with parts, the mission may be terminated for a given aircraft and that aircraft then returns to the Aircraft Readiness Operation (operation 104) or may be routed directly to the Replace Parts Operation 116.

Next, the various aircraft in the fleet fly their missions. Thus, the next operation is to fly the mission (operation 110). Thereafter, post-flight operation is performed (operation 112). Post flight operation may include maintenance, fault detection, and other processes. In both cases, the record index for the bases at which the aircraft operate is taken into account in order to define tasks unique to a base.

A determination is then made whether parts are needed for any given aircraft (operation 114) following completion of a mission. If yes, then a replace parts operation is performed for the aircraft (operation 116). Aircraft may also enter operation 116 if individual asynchronous events cause part maintenance during Mission Assignment (operation 106) or Pre-Flight (operation 108). Aircraft and part states during operation 116 are tracked and used to direct individual aircraft back to Pre-Flight, to Scheduled Downtime (operation 120), or back into operation 116. Operation 116 contains the interfaces necessary for integration with the Supply Chain model. Data to support this operation are stored in the Operations Database and the appropriate Operating Base Database (see reference numerals 202, 206, and 208 in FIG. 2).

If parts were not needed at operation 114, or after replacing parts at operation 116, process 100 proceeds to determining whether scheduled downtime is needed (operation 118). If yes, then scheduled downtime is performed (operation 120). During this operation, information is shared with scheduled downtime data objects and the part maintenance data objects in the Operations Database (operation 202). The databases record index is taken into account to specify downtime operations unique to an individual base.

Thereafter, if scheduled downtime was not needed at operation 118, or after scheduled downtime is completed at operation 120, then process 100 proceeds to a determination whether to exit the scenario at operation 122. If no, then an aircraft ready check operation 104 is performed again for the given aircraft, and process 100 repeats starting with operation 106, or possibly some other later operation. If yes, then the process exits the scenario (operation 124) for that aircraft.

Process 100 is exemplary only. More or fewer operations may be present. Different vehicles or different objects may be used in similar methods. Thus, the example of FIG. 1 does not necessarily limit the claimed inventions or other examples described herein.

FIG. 2 is an illustration of an overall data architecture including model databases, in accordance with an illustrative embodiment. Data architecture 200 of FIG. 2 is an example of a data architecture that makes possible the simulation method, such as process 100 of FIG. 1. Again, while FIG. 2 is presented in the context of the aircraft example of FIG. 1, data architecture 200 is not necessarily limited to aircraft.

Data architecture 200 includes five main databases, but may contain more databases. In some illustrative embodiments, only one operating base database may be present.

Specifically, data architecture 200 includes operations database 202, core database 204, first operating base database 206, second operating base database 208, and results database 210. The purpose of operations database 202 is the collection of tables for specifying an operational scenario, also known as a demand model. The purpose of core database 204 is to integrate other databases during a simulation, such as shown in FIG. 1, especially in conjunction with outside databases that are not necessarily compatible with the other databases.

First operating base database 206 provides a collection of tables for specifying first main operating base supply chain related data. Likewise, second operating base database 208 provides a collection of tables for specifying second main operating base supply chain related data. Second operating base database 208 is optional, but usually aircraft operate from multiple operating bases. Any number of operating bases is possible and each will have their own operating base database. Results database 210 is particularly configured to collect post-simulation results data.

As indicated above, the logistics fleet availability model (LFAM) of the illustrative embodiments has been designed as a database driven application. All input required to setup and run a simulation is supported by data architecture 200. Likewise, all associated runtime data and output history file data is also maintained by data architecture 200. By separating the input data files from the model, a user can build up and maintain any number of scenario description files which are then imported into the model prior to simulation. This architecture enables the maximum reuse of LFAM from project to project, without imposing custom simulation coding requirements.

As indicated by second operating base database 208, the LFAM of the illustrative embodiments supports scaling up of scenarios to include multiple bases from which aircraft operate. Adding additional operating bases to a given scenario requires adding additional inventory control point databases. These databases are the operating base databases at first operating base database 206, second operating base database 208, etc.

Operations database 202 contains the main collection of tables that specify the flight related operational scenario for an LFAM simulation of the illustrative embodiments. Included in this database are all the tables required to specify the fleet size and composition, the mission profiles, part reliability and scheduled maintenance, pre-and post-flight activities, resources, and simulation setup parameters (start date, run duration, number of runs, random seed). Many input tables also capture runtime status data.

Core database 204 synchronizes supply related data between the flight operations part of the model and the supply chain part of the model. This database can be thought of as the master list of inventory control points and supplies. The other databases in the model may have a “Core (shadow)” that provides a local copy of this information. There is code inside LFAM that will generate errors if this information is out of synch between databases. Thus, core database 204 aids in synchronizing and harmonizing different databases.

First operating base database 206 contains supply chain performance data for a specific location, in this case, “MOB 1” (main operating base one). The inventory control point database is also special because it acts as a template data structure. Since this database defines the supply chain data structure, it will always exist in the model. Each location in the model will have a copy of this data structure, populated with local data. These databases are named “icp_+” a unique base name”. The recommended practice is to make N copies of this database, one for each operating base in the model, and then update inventory levels, lead times, and supply replenishment policies to reflect local conditions.

Results database is always present, but its structure changes automatically depending on which metrics blocks the user adds to the model. This database will contain, at a minimum, the output tables needed to support the general metrics block. The general metrics block is a required metrics block that reports basic LFAM results such as availability, fraction of missions completed, etc. The “running stats” and “running stats by aircraft type” tables record the latest statistics which are used to drive some of the plotters on the model notebook. The user may also elect to record a time history of these values by selecting database output on the general metrics block dialog, which is part of a user interface.

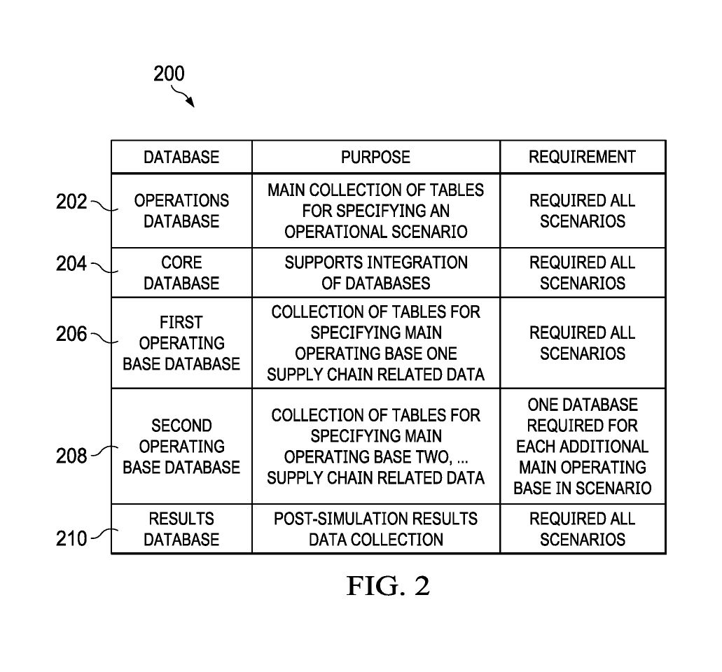

FIG. 3 is an illustration of a block diagram of an analysis process for evaluating sustainment system impact on fleet readiness, in accordance with an illustrative embodiment. Process 100 of FIG. 1 may be part of the simulation portion of process 300 of FIG. 3. Process 300 is supported by data architecture 200 of FIG. 2.

Process 300 begins with identifying an opportunity (operation 302). Opportunities include proposals or requests for proposals, and identification of spares performance based logistics contract possibilities.

Next, process 300 includes identifying business questions (operation 304). An example question may include evaluation of risk of meeting fleet availability thresholds. Another example question may include evaluating the cost and performance benefit of company inventory management. Another example question may include evaluating future demand profiles and spares or repairs capacity risk.

Based on the identification of these relevant questions, process 300 then includes designing a study (operation 306). As part of this operation, data sources are identified, business risks are identified, and metrics and outputs to support decision making are identified. Other aspects of the study may also be identified. Additionally, case matrices are created. If unique logic or metrics is required for the study, then the simulation can be tailored at operation 308.

Next, process 300 includes running the simulation (operation 310). The method of running the simulation may be, for example, process 100 of FIG. 1. During the simulation, many factors are accounted for, such as random part failures, scheduled part removals, aircraft level maintenance and downtime, maintenance resource constraints, supply availability, and the impact of variation overtime.

The simulation may include receiving scenario inputs (operation 312). Scenario inputs include mission profiles, aircraft characteristics, part characteristics, maintenance requirements and constraints, and supply chain performance characteristics.

The simulation may also include inventory optimization (operation 314), which may also include receiving scenario inputs. Inventory optimization may include proposed target stock levels and locations, cost assessment, and other factors. Outputs of the simulation (operation 310) may assess and validate the inventory optimization (operation 314) recommendations.

Finally, process 300 includes processing results (operation 316). Processing results includes assessing the risk of meeting fleet availability thresholds, the cost and performance benefit of inventory management by the company, and future demand profiles and spares and repairs capacity risks. The keys to success may be quick and responsive analysis, availability of tools, and collaboration on inputs and assumptions.

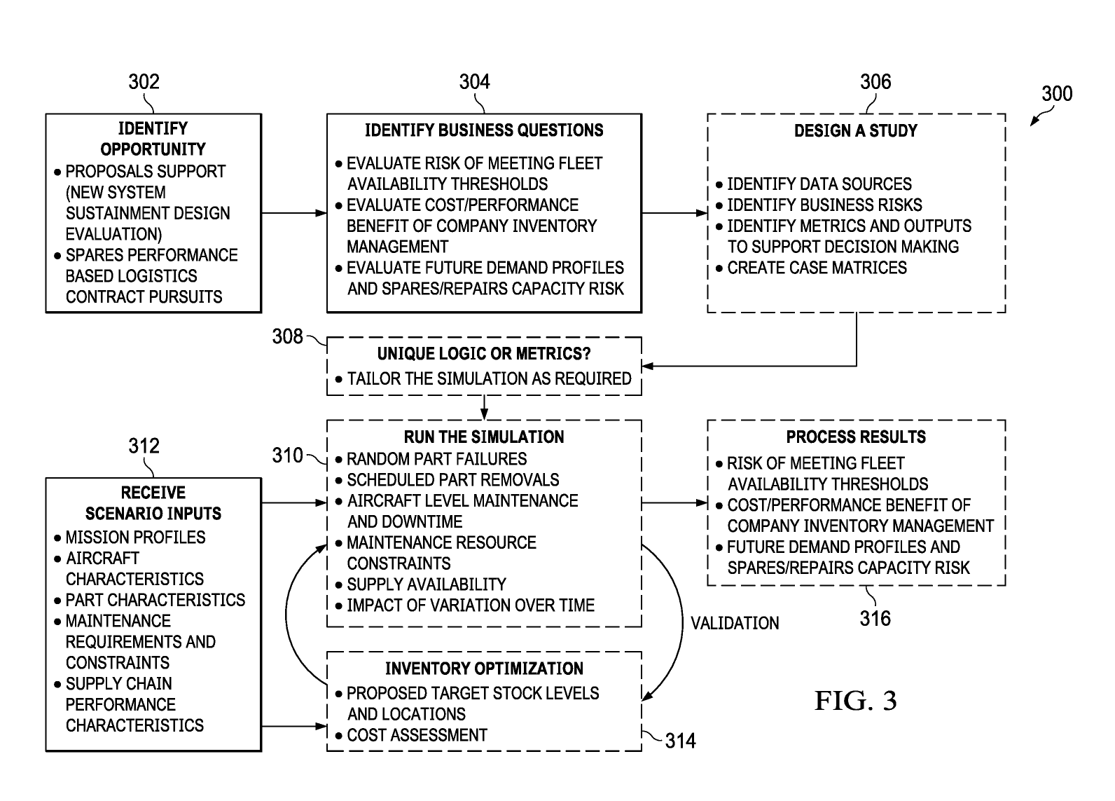

FIG. 4 is an illustration of a block diagram of a high-level simulation configuration process, in accordance with an illustrative embodiment. Process 400 may be a configuration process for the simulation methods described with respect to FIG. 1 or FIG. 3.

Process 400 may begin by configuring a systems operations database (operation 402). Additionally, process 400 may include configuring a supply chain database (operation 404). The supply chain database may be an external database that is not related to the systems operations database.

Next, process 400 includes generating model inventory control point nodes (operation 406). Process 400 then includes generating model system operation objects (operation 408). Process 400 then includes running the simulation (operation 410). Process 400 ends with collecting results (operation 412). Collecting results includes collecting log history files, metrics outputs, and other results.

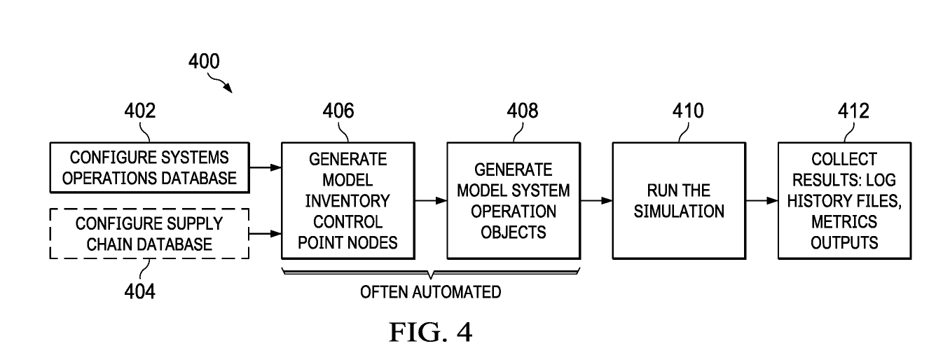

FIG. 5 is an illustration of a block diagram of a data object architecture, in accordance with an illustrative embodiment. Data object architecture 500 is a data structure that describes data objects stored in databases. Data object architecture 500 describes an example of model object interfaces described above. Data object architecture 500, along with data architecture 200 of FIG. 2, allow the simulation methods to operate effectively, such as those described with respect to FIG. 1 and FIG. 3.

As shown in FIG. 6, text within a box refers to an object in question and may be described as an entry in one or more databases. Text above or below the lines connecting the boxes describes the relationships among the objects. The details of data object architecture 500 will vary with different illustrative embodiments, such as for example with different types of vehicles.

In this particular example, aircraft system 502 has a type 504, operates at bases 506, and has system states 508. Bases 506 are a subset of inventory control points (ICPs 510) and have mission schedules 512. Mission schedules demand missions 514, for which type 504 may be assigned.

Type 504 also has parts 516 and needs maintenance tasks 518. Track parts data 520 associates aircraft system 502 with parts 516. Maintenance tasks 518 use resources 522. Track parts data 520 triggers system states 508 and tracks part states 524. Additionally, parts 516 have part states 524.

FIG. 6 is an illustration of a block diagram of a demand model architecture, in accordance with an illustrative embodiment. Again, a demand model specifies a scenario, such as described with respect to FIG. 1 through FIG. 5. Demand model architecture 600 is an example of an architecture for specifying a demand model as described above. Demand model architecture 600 may be an example of or part of operations database 202 in FIG. 2.

Demand model architecture 600 includes system state manager 602, which manages system process model 604. System process model 604 obtains resources. System process model 604 also obtains parts 606 from supply chain model 608. System process model 604 also tracks parts on an aircraft system 610 using executive routines 612. System process model 604 also generates metrics 616 using data capture 614. System process model 604 also interacts with mission schedule manager 618.

Mission schedule manager 618, data capture 614, metrics 616, obtain parts 606, track parts on an aircraft system 610, and executive routines 612 may all be examples of or parts of demand models. Supply chain model 608 may be an external database utilized by system process model 604.

FIG. 7 is an illustration of a block diagram of a supply chain model architecture, in accordance with an illustrative embodiment. As indicated above, a supply chain model architecture may be an external database. However, in an illustrative embodiment, one or more specific supply chain model architectures may be provided for use as an additional database in data architecture 200 of FIG. 2. Supply chain model architecture 700 is one such architecture.

Supply chain manager 702 may interact with supply chain process model 704, which reflects ordering, repairing, condemning, shipping, or other actions taken with respect to parts in a supply chain. Supply chain process model 704 interacts with supply chain data management 706. Supply chain data management 706 includes tracking of stock levels, reorder points, condemnation rates, repair delays, shipping delays, and other factors that affect supply chains.

Demand models 710 obtains parts from operation Obtain Parts 708. Demand models 710 may be one or more demand models as described above.

Supply chain process model 704 executes supply chain related operations and outputs data capture 712. In turn, data capture 712 is used to create metrics 714 for evaluating the simulated supply chain.

FIG. 8 is an illustration of a block diagram of two different supply chain model architectures, in accordance with an illustrative embodiment. FIG. 8 emphasizes that different supply chain models may be used with respect to the simulation models described herein. Supply chain model architecture 800 is similar to supply chain model architecture 700 of FIG. 7.

Supply chain model architecture 800 is simplified in that the part provider need not be specified, but rather is treated as a pool for part ordering and receipt after a time delay. Parts are ordered from and received at an inventory control point, which is the location where inventory is held. The base is the location where demand is generated. The base may be an airport, military base, or even a mobile point such as an aircraft carrier.

Supply chain model architecture 802 is a more complex data architecture, which is described more fully in our U.S. Pat. No. 8,372,817. For supply chain model architecture 802, “ICP” stands for inventory control point, “OEM” stands for original equipment manufacturer, “MOB” stands for main operating base, and “FOB” stands for forward operating base. Each inventory control point interacts with at least two other inventory control points, as shown in FIG. 8. This supply chain architecture supports complex supply networks, provides for part indenture, provides for vendor selection rules, and provides for pass-up rates, part refurbishment, and condemnation of parts.

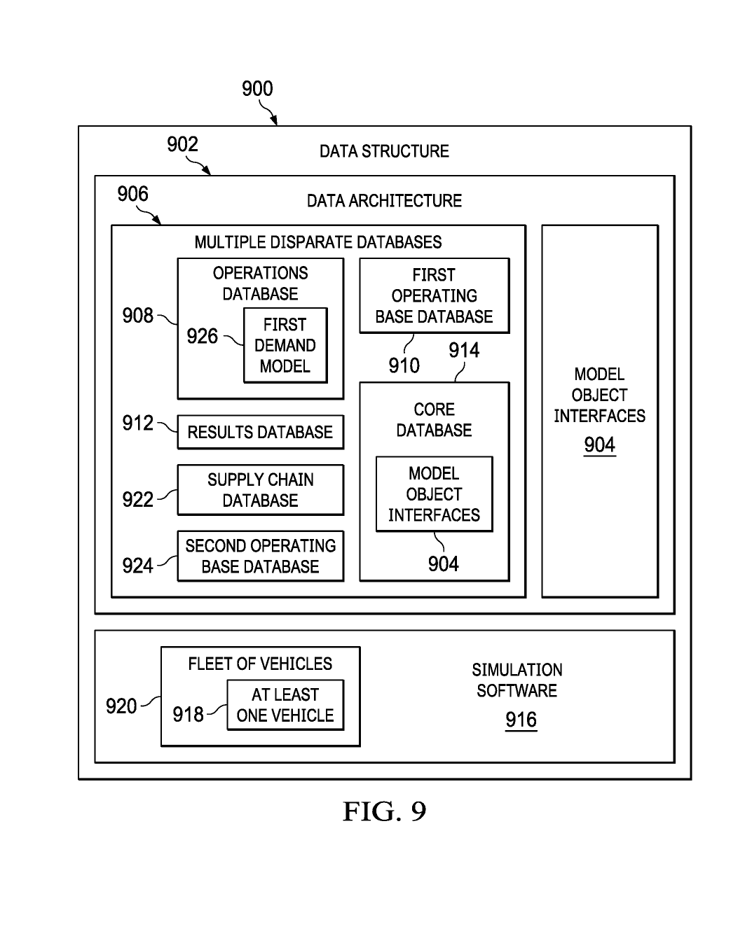

FIG. 9 is an illustration of a block diagram of an improved data architecture, in accordance with an illustrative embodiment. Data structure 900 is a variation of data architecture 200 of FIG. 2. Data structure 900 enables the simulation of providing a level of availability for aircraft within a fleet of aircraft, such as described above with respect to FIG. 1 and FIG. 3. Data structure 900 may also be varied to accommodate other vehicle types, as well as other groups of devices that are maintained over time.

Data structure 900 provides data architecture 902 and model object interfaces 904 for supporting integration of multiple disparate databases 906 useable to model availability of a fleet of vehicles comprising a plurality of vehicles. Model object interfaces 904 aid in allowing objects and databases to communicate with simulation software.

Data structure 900 further includes operations database 908 containing first data specifying a first operational scenario for operating the fleet of vehicles. Data structure 900 further includes first operating base database 910 containing second data specifying first supply chain related data that relates to a first operating base at which the fleet of vehicles may operate.

Data structure 900 further includes results database 912 containing a particular data structure configured to receive post-simulation results of a simulation of operation and maintenance of the fleet of vehicles. Data structure 900 further includes core database 914 containing third data and the model object interfaces, wherein the model object interfaces are configured to allow integration of the operations database, the first operating base database, the results database, and simulation software configured to simulate the operation and maintenance of the fleet of vehicles. Core database 914 may contain model object interfaces 904. However, model object interfaces 904 may be external to multiple disparate databases 906.

Data structure 900 may be varied. For example, data structure 900 may also include simulation software 916. Simulation software 916 is configured to estimate availability of at least one vehicle 918 within fleet of vehicles 920. Simulation software 916 is configured to estimate availability using operations database 908, first operating base database 910, and results database 912.

Data structure 900 may also include supply chain database 922 containing fourth data describing an overall supply chain for performing maintenance of the fleet of vehicles. In this case, model object interfaces 904 of core database 914 are further configured to integrate supply chain database 922 with operations database 908, first operating base database 910, results database 912, and simulation software 916. Data structure 900 may also include second operating base database 924, for when multiple operating bases are part of the simulation.

In another variation, simulation software 916 may be configured to estimate availability of at least one vehicle within the fleet of vehicles, and wherein the simulation software is configured to estimate availability using the operations database, the first operating base database, the results database, and the supply chain database. In a related illustrative embodiment, at least two of the operations database, the first operating base database, the results database, and the supply chain database differ in structure and content, and wherein the core database and model object interfaces allow integration of all data into the simulation software with results processed into the results database.

In another illustrative embodiment, the first data of operations database 908 comprises first demand model 926. In this case, operations database 908 is configured to receive revised or additional demand models, each comprising a different or revised scenario for operating fleet of vehicles 920.

In still another illustrative embodiment, each demand model 926 has an architecture including a corresponding system state manager configured to manage a system state of the simulation; and a corresponding system process model in communication with the corresponding system state manager. The corresponding system process model is configured to obtain resources and data from a plurality of different sources and to output metrics to the results database.

In still another illustrative embodiment, each demand model 926 takes into account scheduled down time of vehicles within fleet of vehicles 920. Additionally, each demand model 926 takes into account labor constraints on vehicle operations processes and part removal and replacement for fleet of vehicles 920.

Other variations are possible, at least as described with respect to FIG. 1 through FIG. 7. Thus, the example provided in FIG. 8 does not necessarily limit the claimed inventions.

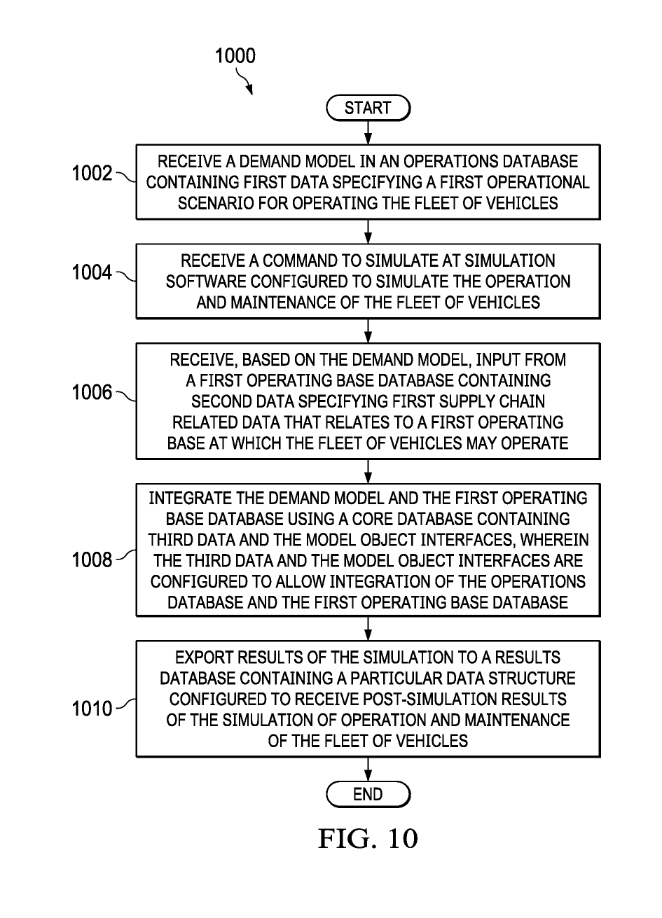

FIG. 10 is an illustration of a flow chart of a process for modeling servicing of a fleet of aircraft using an improved data architecture, in accordance with an illustrative embodiment. Method 1000 may be executed using one or more data processing systems, such as data processing system 1100 of FIG. 11. Method 1000 is a variation of the methods described above, including the methods and processes described with respect to FIG. 1 and FIG. 3. Process 100 may be characterized as a method for modeling availability of a fleet of vehicles using a data structure comprising a data architecture and model object interfaces for supporting integration of multiple disparate databases, the method executed solely in a computer.

Method 1000 includes receiving a demand model in an operations database containing first data specifying a first operational scenario for operating the fleet of vehicles (operation 1002). Method 1000 also includes receiving a command to simulate at simulation software configured to simulate the operation and maintenance of the fleet of vehicles (operation 1004).

Method 1000 also includes receiving, based on the demand model, input from a first operating base database containing second data specifying first supply chain related data that relates to a first operating base at which the fleet of vehicles may operate (operation 1006). Method 1000 also includes integrating the demand model and the first operating base database using a core database containing third data and the model object interfaces, wherein the third data and the model object interfaces are configured to allow integration of the operations database and the first operating base database (operation 1008).

Method 1000 also includes exporting results of the simulation to a results database containing a particular data structure configured to receive post-simulation results of the simulation of operation and maintenance of the fleet of vehicles (operation 1010). In one illustrative embodiment, method 1000 may terminate thereafter.

Method 1000 may be varied. For example, integrating may also include using the core database to integrate the results database with the demand model and the first operating base database. In another variation, receiving input further includes receiving input from a supply chain database containing fourth data describing an overall supply chain for performing maintenance of the fleet of vehicles.

Building on this variation, method 1000 may also include using the core database to integrate the supply chain database with the demand model and the first operating base database. Building further on this variation, method 1000 may also include estimating a cost of maintaining the availability of the fleet of aircraft, and exporting the cost to the results database.

Other variations are possible, at least as described with respect to FIG. 1 through FIG. 9. More or fewer operations may be present, and the operations described above may be varied. For example, vehicles other than aircraft could be tracked, as could other types of devices that are tracked over time. Thus, the example provided in FIG. 10 does not necessarily limit the claimed inventions.

Turning now to FIG. 11, an illustration of a data processing system is depicted in accordance with an illustrative embodiment. Data processing system 1100 in FIG. 11 is an example of a data processing system that may be used to implement the illustrative embodiments described above. In this illustrative example, data processing system 1100 includes communications fabric 1102, which provides communications between processor unit 1104, memory 1106, persistent storage 1108, communications unit 1110, input/output unit 1112, and display 1114.

Processor unit 1104 serves to execute instructions for software that may be loaded into memory 1106. This software may be an associative memory, which is a type of content addressable memory, or software for implementing the processes described herein. Thus, for example, software loaded into memory 1106 may be software for executing the algorithms described herein. Thus, such software may be program code for implementing the illustrative embodiments described herein.

Processor unit 1104 may be a number of processors, a multi-processor core, or some other type of processor, depending on the particular implementation. A number, as used herein with reference to an item, means one or more items. Further, processor unit 1104 may be implemented using a number of heterogeneous processor systems in which a main processor is present with secondary processors on a single chip. As another illustrative example, processor unit 1104 may be a symmetric multi-processor system containing multiple processors of the same type.

Memory 1106 and persistent storage 1108 are examples of storage devices 1116. A storage device is any piece of hardware that is capable of storing information, such as, for example, without limitation, data, program code in functional form, and/or other suitable information, either on a temporary basis and/or a permanent basis. Storage devices 1116 may also be referred to as computer-readable storage devices in these examples. Memory 1106, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory drive, a rewritable optical disk, a rewritable magnetic tape, or some combination of the above mentioned devices. The media used by persistent storage 1108 also may be removable. For example, a removable hard drive may be used for persistent storage 1108.

Communications unit 1110, in these examples, provides for communications with other data processing systems or devices. In these examples, communications unit 1110 is a network interface card. Communications unit 1110 may provide communications through the use of either physical or wireless communications links, or both.

Input/output unit 1112 allows for input and output of data with other devices that may be connected to data processing system 1100. For example, input/output unit 1112 may provide a connection for user input through a keyboard, a mouse, and/or some other suitable type of input device. Further, input/output unit 1112 may send output to a printer. Display 1114 provides a mechanism to display information to a user.

Instructions for the operating system, applications, and/or programs may be located in storage devices 1116, which are in communication with processor unit 1104 through communications fabric 1102. In these illustrative examples, the instructions are in a functional form on persistent storage 1108. These instructions may be loaded into memory 1106 for execution by processor unit 1104. The processes of the different embodiments may be performed by processor unit 1104 using computer implemented instructions, which may be located in a memory, such as memory 1106.

These instructions are referred to as program code, computer-useable program code, or computer-readable program code that may be read and executed by a processor in processor unit 1104. The program code in the different embodiments may be embodied on different physical or computer-readable storage media, such as memory 1106 or persistent storage 1108.

Computer-usable program code 1118 is located in a functional form on computer-readable media 1120 that is selectively removable and may be loaded onto or transferred to data processing system 1100 for execution by processor unit 1104. Computer-usable program code 1118 and computer-readable media 1120 form computer program product 1122 in these examples. In one example, computer-readable media 1120 may be computer-readable storage media 1124 or computer-readable signal media 1126. Computer-readable storage media 1124 may include, for example, an optical or magnetic disk that is inserted or placed into a drive or other device that is part of persistent storage 1108 for transfer onto a storage device, such as a hard drive, that is part of persistent storage 1108. Computer-readable storage media 1124 also may take the form of a persistent storage, such as a hard drive, a thumb drive, or a flash memory, that is connected to data processing system 1100. In some instances, computer-readable storage media 1124 may not be removable from data processing system 1100.

Alternatively, computer-usable program code 1118 may be transferred to data processing system 1100 using computer-readable signal media 1126. Computer-readable signal media 1126 may be, for example, a propagated data signal containing computer-usable program code 1118. For example, computer-readable signal media 1126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, computer-usable program code 1118 may be downloaded over a network to persistent storage 1108 from another device or data processing system through computer-readable signal media 1126 for use within data processing system 1100. For instance, program code stored in a computer-readable storage medium in a server data processing system may be downloaded over a network from the server to data processing system 1100. The data processing system providing computer-usable program code 1118 may be a server computer, a client computer, or some other device capable of storing and transmitting computer-usable program code 1118.

The different components illustrated for data processing system 1100 are not meant to provide architectural limitations to the manner in which different embodiments may be implemented. The different illustrative embodiments may be implemented in a data processing system including components, in addition to or in place of those, illustrated for data processing system 1100. Other components shown in FIG. 11 can be varied from the illustrative examples shown. The different embodiments may be implemented using any hardware device or system capable of running program code. As one example, the data processing system may include organic components integrated with inorganic components and/or may be comprised entirely of organic components, excluding a human being. For example, a storage device may be comprised of an organic semiconductor.

In another illustrative example, processor unit 1104 may take the form of a hardware unit that has circuits that are manufactured or configured for a particular use. This type of hardware may perform operations without needing program code to be loaded into a memory from a storage device to be configured to perform the operations.

For example, when processor unit 1104 takes the form of a hardware unit, processor unit 1104 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, or other suitable types of hardware devices. With this type of implementation, computer-usable program code 1118 may be omitted because the processes for the different embodiments are implemented in a hardware unit.

In still another illustrative example, processor unit 1104 may be implemented using a combination of processors found in computers and hardware units. Processor unit 1104 may have a number of hardware units and a number of processors that are configured to run computer-usable program code 1118. With this depicted example, some of the processes may be implemented in the number of hardware units, while other processes may be implemented in the number of processors.

As another example, a storage device in data processing system 1100 is any hardware apparatus that may store data. Memory 1106, persistent storage 1108, and computer-readable media 1120 are examples of storage devices in a tangible form.

In another example, a bus system may be used to implement communications fabric 1102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, a cache. A memory may also be memory 1106, found in an interface and memory controller hub that may be present in communications fabric 1102.

Data processing system 1100 may also include an associative memory. An associative memory may be in communication with communications fabric 1102. An associative memory may also be in communication with, or in some illustrative embodiments, be considered part of storage devices 1116. Additional associative memories may be present.

As used herein, the term “entity” refers to an object that has a distinct, separate existence, though such existence need not be a material existence. Thus, abstractions and legal constructs may be regarded as entities. As used herein, an entity need not be animate. Associative memories work with entities.

The different illustrative embodiments can take the form of an entirely hardware embodiment, an entirely software embodiment, or an embodiment containing both hardware and software elements. Some embodiments are implemented in software, which include but are not limited to forms such as, for example, firmware, resident software, and microcode.

Furthermore, the different embodiments can take the form of a computer program product accessible from a computer-usable or computer-readable medium providing program code for use by or in connection with a computer or any device or system that executes instructions. For the purposes of this disclosure, a computer-usable or computer-readable medium can generally be any tangible apparatus that can contain, store, communicate, propagate, or transport the program for use by or in connection with the instruction execution system, apparatus, or device.

The computer-usable or computer-readable medium can be, for example, without limitation an electronic, magnetic, optical, electromagnetic, infrared, or semiconductor system, or a propagation medium. Non-limiting examples of a computer-readable medium include a semiconductor or solid state memory, magnetic tape, a removable computer diskette, a random access memory (RAM), a read-only memory (ROM), a rigid magnetic disk, and an optical disk. Optical disks may include compact disk read-only memory (CD-ROM), compact disk read/write (CD-R/W), or DVD.

Further, a computer-usable or computer-readable medium may contain or store a computer-readable or computer-usable program code, such that when the computer-readable or computer-usable program code is executed on a computer, the execution of this computer-readable or computer-usable program code causes the computer to transmit another computer-readable or computer-usable program code over a communications link. This communications link may use a medium that is, for example without limitation, physical or wireless.

A data processing system suitable for storing and/or executing computer-readable or computer-usable program code will include one or more processors coupled, directly or indirectly, to memory elements through a communications fabric, such as a system bus. The memory elements may include local memory employed during actual execution of the program code, bulk storage, and cache memories which provide temporary storage of at least some computer-readable or computer-usable program code to reduce the number of times code may be retrieved from bulk storage during execution of the code.

Input/output unit or input/output devices can be coupled to the system either directly or through intervening input/output controllers. These devices may include, for example, without limitation, keyboards, touch screen displays, or pointing devices. Different communications adapters may also be coupled to the system to enable the data processing system to become coupled to other data processing systems, remote printers, or storage devices through intervening private or public networks. Non-limiting examples of modems and network adapters are just a few of the currently available types of communications adapters.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A data structure comprising model object interfaces and a data architecture for supporting integration of multiple disparate databases useable to model availability of a fleet of vehicles comprising a plurality of vehicles, the data structure further comprising:
an operations database containing first data specifying a first operational scenario for operating the fleet of vehicles;
a first operating base database containing second data specifying first supply chain related data that relates to a first operating base at which the fleet of vehicles are configured to operate;
a results database containing a particular data structure configured to receive post-simulation results of a simulation of operation and maintenance of the fleet of vehicles; and
a core database containing third data and the model object interfaces, wherein the model object interfaces are configured to allow integration of the operations database, the first operating base database, the results database, and simulation software, and wherein the simulation software is configured to simulate the operation and maintenance of the fleet of vehicles.

2. The data structure of claim 1 further comprising:
the simulation software configured to estimate availability of at least one vehicle within the fleet of vehicles, and wherein the simulation software is configured to estimate availability using the operations database, the first operating base database, and the results database.

3. The data structure of claim 1 further comprising:
a supply chain database containing fourth data describing an overall supply chain for performing the maintenance of the fleet of vehicles, and wherein the model object interfaces of the core database are further configured to integrate the supply chain database with the operations database, the first operating base database, the results database, and the simulation software.

4. The data structure of claim 3 further comprising:
the simulation software configured to estimate availability of at least one vehicle within the fleet of vehicles, and wherein the simulation software is configured to estimate availability using the operations database, the first operating base database, the results database, and the supply chain database.

5. The data structure of claim 4 wherein at least two of the operations database, the first operating base database, the results database, or the supply chain database differ in structure and content, and wherein the core database and model object interfaces allow integration of data into the simulation software with results processed into the results database.

6. The data structure of claim 3, wherein at least two of the operations database, the first operating base database, the results database, or the supply chain database differ in structure and content, and wherein the core database and model object interfaces allow integration of data into the simulation software with results processed into the results database.

7. The data structure of claim 1, wherein the first data of the operations database comprises a first demand model, and wherein the operations database is configured to receive revised or additional demand models, each of the revised or additional demand models comprising a different or revised scenario for operating the fleet of vehicles.

8. The data structure of claim 7 wherein each demand module comprises the first demand model and the revised or additional demand models, each demand model has an architecture comprising:
a corresponding system state manager configured to manage a system state of the simulation; and
a corresponding system process model in communication with the corresponding system state manager, the corresponding system process model configured to obtain resources and data from a plurality of different sources and to output metrics to the results database.

9. The data structure of claim 8, wherein each demand model takes into account scheduled down time of vehicles within the fleet of vehicles.

10. The data structure of claim 9, wherein each demand model takes into account labor constraints on vehicle operations processes and part removal and replacement for the fleet of vehicles.

11. A method for modeling availability of a fleet of vehicles using a data structure comprising model object interfaces and a data architecture for supporting integration of multiple disparate databases, the method executed solely in a computer, the method comprising:
receiving a demand model in an operations database containing first data specifying a first operational scenario for operating the fleet of vehicles;
receiving a command to simulate at simulation software configured to simulate a simulation of operation and maintenance of the fleet of vehicles;
receiving, based on the demand model, input from a first operating base database containing second data specifying first supply chain related data that relates to a first operating base at which the fleet of vehicles are configured to operate;
integrating the demand model and the first operating base database using a core database containing third data and the model object interfaces, wherein the third data and the model object interfaces are configured to allow integration of the operations database and the first operating base database; and
exporting results of the simulation of operation and maintenance of the fleet of vehicles to a results database containing a particular data structure configured to receive post-simulation results of the simulation of operation and maintenance of the fleet of vehicles.

12. The method of claim 11, wherein integrating also includes using the core database to integrate the results database with the demand model and the first operating base database.

13. The method of claim 11, wherein receiving input further includes receiving input from a supply chain database containing fourth data describing an overall supply chain for performing the maintenance of the fleet of vehicles.

14. The method of claim 13 further comprising:
using the core database to integrate the supply chain database with the demand model and the first operating base database.

15. The method of claim 14 further comprising:
estimating a cost of maintaining the availability of the fleet of vehicles, and exporting the cost to the results database.

16. A computer comprising:
a processor; and
a non-transitory computer recordable storage medium in communication with the processor, the non-transitory computer recordable storage medium storing program code which, when executed by the processor, performs a method for modeling availability of a fleet of vehicles using a data structure comprising model object interfaces and a data architecture for supporting integration of multiple disparate databases, the program code comprising:
program code for receiving a demand model in an operations database containing first data specifying a first operational scenario for operating the fleet of vehicles;
program code for receiving a command to simulate at simulation software configured to simulate a simulation of operation and maintenance of the fleet of vehicles;
program code for receiving, based on the demand model, input from a first operating base database containing second data specifying first supply chain related data that relates to a first operating base at which the fleet of vehicles are configured to operate;
program code for integrating the demand model and the first operating base database using a core database containing third data and the model object interfaces, wherein the third data and the model object interfaces are configured to allow integration of the operations database and the first operating base database; and
program code for exporting results of the simulation of operation and maintenance of the fleet of vehicles to a results database containing a particular data structure configured to receive post-simulation results of the simulation of operation and maintenance of the fleet of vehicles.

17. The computer of claim 16, wherein the program code for integrating also includes program code for using the core database to integrate the results database with the demand model and the first operating base database.

18. The computer of claim 16, wherein the program code for receiving input further includes program code for receiving input from a supply chain database containing fourth data describing an overall supply chain for performing the maintenance of the fleet of vehicles.

19. The computer of claim 18, wherein the program code further comprises:
program code for using the core database to integrate the supply chain database with the demand model and the first operating base database.

20. The computer of claim 19, wherein the program code further comprises:
program code for estimating a cost of maintaining the availability of the fleet of vehicles, and exporting the cost to the results database.
